(19) United States
(12) Patent Application Publication
(10) Pub. No.: US 2003/0025353 A1
(43) Pub. Date: Feb. 6, 2003

(54) Side impact support

(75) Inventor: Stefan Gosmann, Bad Wunnenberg (DE)

Correspondence Address: Ursula B. Day, Suite 3220, 350 Fifth Avenue, New York, NY, 10118, US

(73) Assignee: BENTELER AUTOMOBIL TECHNIK GMBH & CO. KG, Paderborn (DE)

(21) Appl. No.: 10/212,000

(22) Filed: Aug. 2, 2002

(30) Foreign Application Priority Data
Aug. 2, 2001 (DE) 101 38 034.8

(51) Int. Cl. B60J 5/04

(52) U.S. Cl. 296/146.6

(57) ABSTRACT

The invention refers to a side impact support for incorporation into the door of a motor vehicle, wherein the side impact support has a longitudinal profile with end portion towards the door column, and which is configured asymmetrical with respect to the its center transverse plane MQ and which has a reinforcement in the portion adjacent and corresponding to the sitting position of a passenger, and wherein the cross section of the first portion is increased as compared to a second portion which is adjacent, and wherein the cross section of the profile along most of the length is preferably configured hat shaped.

### CROSS-REFERENCES TO RELATED APPLICATIONS

This application claims the priority of German Patent Application Serial No. 101 38 034.8, filed Aug. 2, 2001, pursuant to 35 U.S.C. 119(a)-(d), the subject matter of which is incorporated herein by reference.

### FIELD OF THE INVENTION

The invention relates in general to side impact supports and in particular to an improved side impact support for incorporation into a motor vehicle, and which is provided with reinforcement for increased resistance to impact.

### BACKGROUND OF THE INVENTION

Side impact supports of a motor vehicle protect the passengers in a motor vehicle from crash-related injuries when the motor vehicle incurs a crash-related side impact. The side impact supports are therefore used as reinforcements for vehicle doors. They are designed so the side impact supports exhibit a high stiffness transverse to the direction in which the vehicle moves and in dependence on the stability of the base construction of the vehicle.

From the prior art, for example EP 0 728 607 A2, a tube construction as well as a collapsible construction of a side impact support with flat shaped and trapezoidally flaring end section is disclosed. WO 94/07709 discloses a side impact support, with a horseshoe type profile along substantially its entire length, and tapering in width and also in height toward the side of the end sections of the door column.

Side impact supports of the type as afore-described are mostly manufactured from metal drawing sheets. Their hat-like profiles have the advantage, that they can be usually manufactured in one piece and that they are lighter than the side impact supports manufactured from tubes.

The side impact support manufactured from profiled metal drawing sheets have in common that they are flattened toward the end sections, where they are fitted into the door metal. They strengthen the structure of the door construction and absorb the impact force generated by a side crash. The side impact support which is known from the afore-described WO 94/07709, beginning from the middle towards each of the ends, is tapering off in both, width and height dimension, A weak point of the side impact support is in the area of the passenger's sitting position, where the side impact support can yield to axial compression and can buckle.

It would therefore be desirable and advantageous to provide an improved side impact support designed to obviate prior art shortcomings which exhibits improved crash condition behavior and to thereby realize a higher level of protection for the passengers of a motor vehicle.

### SUMMARY OF THE INVENTION

According to one aspect of the present invention, an improved side impact support is provided which avoids the drawbacks of the prior art and which is configured so as to have a reinforced section which better withstands a side impact of a motor vehicle and which therefore better protects the passengers in seated position.

According to a further aspect of the invention, the improved side impact support is based on an asymmetrical configuration which is designed to provide the support with the necessary reinforcement, so that the longitudinal profile of the side impact support is configured in asymmetrical fashion relative to its center transverse plane to thereby specifically reinforce the first longitudinal section of the support which faces the passenger in a seated position.

In accordance with these aspects, the side impact support is configured in such a fashion such that in the area adjacent to the passenger in seated position, an impact upon the passenger during a crash is minimized, or at least that the impact is extremely reduced.

In accordance with the present invention, the deformation and the intrusion of the side impact support is shifted to areas that are less crucial for impact stress on the vehicle passengers so as to keep the impact force very low. Thus, depending on the installation position, the side impact support is strengthened specifically in the areas corresponding to the position of the hip, abdomen and thorax of the car passenger, so that through the reinforcement, the deformation of the side impact support is shifted to the forward leg area. In that area, there is a greater amount of free space available for a passive yielding of the passenger's legs which thereby contributes to the degradation of the crash force through displacement of the side impact support.

In accordance with another feature of the invention, the reinforcement of the side impact support in the area corresponding to the sitting position of the passengers, is preferably realized by enlarging the diameter of the side impact support, such that in a first longitudinal portion of the side impact support, the width as well as the height are increased as compared to an adjacent second longitudinal portion of the side impact support which extends in direction of the area corresponding to the legs of the passenger.

In accordance with another feature of the present invention, the reinforcement in the first portion, of course, can also be realized by other constructive means, for example by means of a striking plate associated with the first portion and/or by other reinforcing means suitable for this area.

In accordance with a further feature of the present invention, the longitudinal profile of the side impact support can be configured as an open, as well as a closed profile.

According to yet another feature of the side impact support according to the present invention, the longitudinal profile of the side impact support extending at least along a substantial part of its length has a hat-shaped configuration. The profile has a central web and two legs with longitudinal edges. Disposed at the longitudinal edges are transversely projecting side flanges.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic representation of a side view of a passenger seated in a passenger compartment of a vehicle and a side impact support according to the present invention;

FIG. 2 is top view of a side impact support.

FIG. 3 is a cross-sectional view of the side impact support showing a hat-like configuration.

### DETAILED DESCRIPTION OF PREFERRED EMBODIMENTS

Throughout all the Figures, same or corresponding elements are generally indicated by same reference numerals.

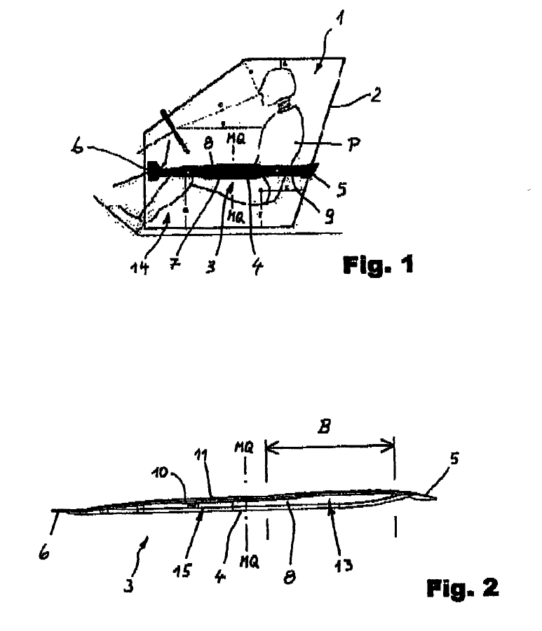

Turning now to the drawing, and in particular to FIG. 1, there is shown a side view of the passenger compartment 1 of a motor vehicle, which is not shown here in detail. Passenger P is seen in a seated position. Incorporated into vehicle door 2 is a side impact support 3, which has a cross sectional hat-like profile 4 extending at least along the greater portion of the support and has end portions 5 and 6 at the side facing the door column. The longitudinal profile 4 has a central web 4 with two legs 8, 9 extending sideways, with longitudinal edges 10 provided with transversely extending side flanges 11, 12.

The side impact support 3 is produced from sheet metal and is configured in such a manner so as to reinforce the vehicle door 2 when incorporated therein, such that upon a side impact energy from the crash impact can be absorbed.

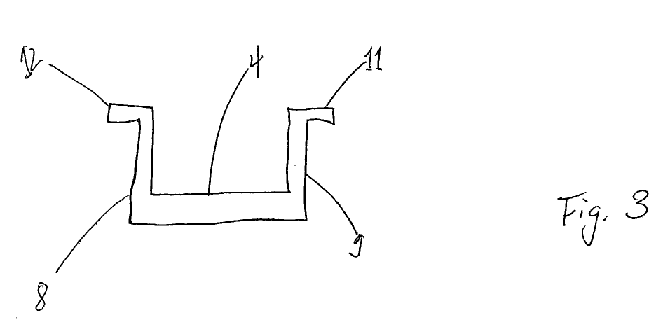

The longitudinal profile 4 is configured asymmetrical relative to its center transverse plane MQ, as shown in FIG. 2. In a first longitudinal section 13 facing the seated position of passenger P, the longitudinal section 4 is reinforced. The reinforced region is shown in FIG. 2 designated with B. The cross section of the first longitudinal section 13 of profile 4 is enlarged as compared to the second longitudinal section 15 which is adjacent the first section 13 in the direction of the leg room 14 of passenger P. Thus in the second section, the width of the web 7 as well as the height of the legs 8, 9 are both increased.

By reinforcing the first longitudinal section 13 of the side impact support in a targeted manner, a reduction of the effect of the crash impact upon the passenger P is realized. The deformation and the intrusion, that is the charge, respectively the displacement of the side impact support 3 is moved into the second longitudinal section 15, that is, into an area, which, for the passenger P is less crucial with respect to impact. As a result, an increased protection is realized in the corresponding areas with respect to the hip, abdomen and thorax of the passenger P.

While the invention has been illustrated and described as embodied in a side impact support, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A side impact support for incorporation into the door of a motor vehicle comprising:
a longitudinal profile with end portions facing a door column of the motor vehicle and configured asymmetrical with respect to a first and second sections each extending from a center transverse plane of the profile;
wherein the first section corresponding to an area facing a seated passenger is provided with a reinforcement.

2. The side impact support of claim 1, wherein the reinforcement is configured as an increase in a cross section of the first section as compared to a cross section of the second section.

3. The side impact support of claim 1, wherein the cross section of the longitudinal profile is configured as web with legs extending from each side of the web and ending in transverse flanges.

4. The side impact support of claim 1, wherein the cross section of the longitudinal profile is configured in the shape of a hat.

5. The side impact support of claim 1, wherein the reinforcement is configured as striking plate.
